(19) United States
(12) Patent Application Publication
(10) Pub. No.: US 2004/0220290 A1
(43) Pub. Date: Nov. 4, 2004

(54) Flexible moldings of foamed polyurethane and their use

(76) Inventors: Wolfgang Grimm, Leverkusen (DE); Erhard Michels, Koln (DE); Marc Schutze, Dusseldorf (DE)

Correspondence Address: Patent Department, Bayer Polymers LLC, 100 Bayer Road, Pittsburgh, PA, 15205-9741, US

(21) Appl. No.: 10/832,124

(22) Filed: Apr. 26, 2004

(30) Foreign Application Priority Data
Apr. 30, 2003 (DE) 10319393.6

(51) Int. Cl. C08G 18/00; C08J 9/00

(52) U.S. Cl. 521/170; 521/174

(57) ABSTRACT

The invention relates to flexible moldings of foamed polyurethane with densities of <500 kg/m³, preferably of <350 kg/m³, and with high molding stability (i.e having a maximum molding shrinkage of 1.5% according to DIN ISO 02769) which are based on special components. These flexible polyurethane moldings are particularly suitable in the shoe sector.

### BACKGROUND OF THE INVENTION

The invention relates to flexible moldings of foamed polyurethane having densities of less than 500 kg/m³ and which exhibit high molding stability (i.e. having a maximum molding shrinkage of 1.5% according to DIN ISO 02769). These foamed polyurethanes are based on specific components, and are suitable to be used in the shoe sector.

In EP-A 1 225 199 a process for producing flexible microcellular elastomers with low density is disclosed. Carbon dioxide (CO₂) is used as blowing agent, and it is dissolved either in the isocyanate component, the polyol component or both. These elastomers which are blown with CO₂ exhibit a uniform cellular structure and a low content of urea rigid segments. There is a disadvantage, however, in that the mechanical properties of these polyether-based elastomers, such as tensile strength, tear propagation resistance and resilience, are not good.

The object of the present invention was to provide polyurethane moldings that do not exhibit these disadvantages. Rather, the polyurethane molding of the present invention should have a high tensile strength and a high resilience, with molding densities of less than 500 kg/m³, and under dynamic loading, and exhibit a low urea content.

This object was able to be achieved by the moldings according to the invention.

### SUMMARY OF THE INVENTION

The present invention is directed to flexible moldings of foamed polyurethane wherein the molding densities are less than 500 kg/m³, and preferably less than 350 kg/m³, and which exhibit a maximum molding shrinkage of 1.5% (according to DIN ISO 02769). These flexible moldings of foamed polyurethane comprise the reaction product of:

a) one or more organic isocyanates having 2 to 4 NCO groups per molecule and an NCO content of 6 to 49 wt. %;

b) at least one polyol component selected from the group consisting of

b1) one or more polyetherester polyols with a number-average molecular weight of 800 g/mol to 6000 g/mol, preferably of 1200 g/mol to 4000 g/mol, a number-average functionality of 1.7 to 4, preferably of 1.8 to 2.7, and a ratio by weight of ether groups to ester groups of the polyetherester polyol of 0.05:0.95 to 0.48:0.52, preferably of 0.08:0.92 to 0.3:0.7, wherein the polyetherester polyols are the polycondensation product of

b1.1) one or more dicarboxylic acids having up to 12 carbon atoms and/or their derivatives,

b1.2) one or more polyether polyol components selected from the group consisting of:

(a) one or more polyether polyols having a number-average molecular weight of 1000 g/mol to 8000 g/mol, preferably of 1500 g/mol to 6000 g/mol, an average functionality of 1.7 to 4, preferably of 1.8 to 2.7, and an ethylene oxide content of 10 to 40 wt. %, preferably of 15 to 35 wt. %, most preferably 18 to 32 wt. %, and

(b) one or more ether-based polymer polyols having an OH number of 10 to 149 and average functionalities of 1.7 to 4, preferably of 1.8 to 3.5, and which contain 1 to 50 wt. %, preferably 1 to 45 wt. % of solids, based on the weight of the total amount of (b),

b1.3) one or more polyols having a number-average molecular weight of 62 to 750 g/mol, preferably of 62 g/mol to 400 g/mol, most preferably of 62 g/mol to 200 g/mol, a number-average functionality of 2 to 8 and having at least 2 terminal OH groups per molecule,

and, optionally,

b1.4) one or more ester-based polymer polyols which have OH numbers of 10 to 149 and average functionalities of 1.7 to 4, preferably of 1.8 to 3.5 and which contain 1 to 50 wt. %, preferably 1 to 45 wt. % of solids, based on the weight of the total amount of b1.4), and

b2) a mixture of

b2.1) from 52 to 95 wt. %, preferably from 70 to 92 wt. %, based on 100% of the combined weight of b2.1) and b2.2), of at least one polyester polyol component selected from the group consisting of:

(a) one or more polyester polyols having a number-average molecular weight of 1000 to 4000 g/mol and a functionality of 1.7 to 4, and

(b) one or more ester-based polymer polyols having OH numbers of 10 to 149 and average functionalities of 1.7 to 4, preferably of 1.8 to 3.5, which contain 1 to 50 wt. %, preferably 1 to 45 wt. % of solids, based on the total amount of (b), and

b2.2) 5 to 48 wt. %, preferably 8 to 30 wt. %, based on 100% of the combined weight of b2.1) and b2.2), of one or more polyether polyol components selected from the group consisting of:

(a) one or more ethylene oxide group-containing polyether polyols having a number-average molecular weight of 900 to 18,000 g/mol, preferably 2000 to 8000 g/mol, a functionality of 1.7 to 4, preferably 1.8 to 2.7, and an ethylene oxide content of 10 to 40 wt. %, preferably 15 to 35 wt. %, most preferably 18 to 32 wt. %, and

(b) one or more ether-based polymer polyols which have OH numbers of 10 to 149 and average functionalities of 1.7 to 4, preferably 1.8 to 3.5, and which contain 1 to 50 wt. %, preferably 1 to 45 wt. % of solids, based on the weight of the total amount of (b),

c) 5 to 25 wt. %, based on 100% of the combined weight of components b) and c), of one or more crosslinking agents and/or chain extenders,

d) one or more blowing agent components selected from the group consisting of:

d1) nitrogen, air, carbon dioxide, and mixtures thereof, and

d2) at least one blowing agent component from the group consisting of chemical blowing agents and physical blowing agents with boiling points in the range of −30° C. to 75° C.,

and, optionally,

e) one or more emulsifiers,

f) one or more additives and auxiliary substances,

g) one or more catalysts,

wherein the Isocyanate Index is from 95 to 115.

In accordance with the present invention, blowing agent component d1) is preferably added to the polyol component b) and/or to the isocyanate a). In addition, blowing agent component d2) is preferably added to the polyol component b).

Isocyanate Index as used herein signifies the molar ratio of the NCO groups in the isocyanate component relative to the NCO-reactive terminal groups in components b), c) and d) multiplied by 100. A coefficient of 100 corresponds to a stoichiometric amount of isocyanate groups to NCO-reactive terminal groups.

A further aspect of the present invention is directed to a process for producing the flexible moldings from foamed polyurethane, wherein the moldings have densities of less than 500 kg/m³, preferably of <350 kg/m³, and exhibit a maximum molding shrinkage of 1.5% (as measured according to DIN ISO 02769). This process comprises the steps of:

A) reacting component a) one or more organic isocyanates as described above, with component b) at least one polyol component as described above, and component c) one or more crosslinking agents and/or chain extenders, in a mold, with the addition of component d) the blowing agent, and optionally component e) the emulsifier and/or component f) the additives/auxiliary substances, optionally in the presence of component g) one or more catalysts, in amounts such that the Isocyanate Index is from 95 to 115, and

B) removing the resultant molding from the mold.

Suitable organic isocyanates to be used as starting component a) for the moldings according to the invention include the aliphatic, cycloaliphatic, araliphatic, aromatic and heterocyclic polyisocyanates, such as are described in, for example, by W. Siefken in “Justus Liebigs Annalen der Chemie”, 562, pp. 75 to 136, the disclosure of which is herein incorporated by reference. These polyisocyanates include, for example, those which correspond to the general formula:

Q (NCO)ₙ

wherein:

n represents 2 to 4, preferably 2, and

Q represents an aliphatic hydrocarbon group having 2 to 18, preferably 6 to 10 carbon atoms, a cycloaliphatic hydrocarbon group having 4 to 15, preferably 5 to 10 carbon atoms, an aromatic hydrocarbon group having 6 to 15, preferably 6 to 13 carbon atoms, or an araliphatic hydrocarbon group having 8 to 15, preferably 8 to 13 carbon atoms.

Some examples of suitable polyisocyanates for component a) of the present invention include compounds such as, for example, ethylene diisocyanate, 1,4-tetramethylene diisocyanate, 1,6-hexamethylene diisocyanate (HDI), 1,12-dodecane diisocyanate, cyclobutane-1,3-diisocyanate, cyclohexane-1,3- and -1,4-diisocyanate, as well as any mixtures of these isomers, 1-isocyanato-3,3,5-trimethyl-5-isocyanatomethyl-cyclohexane, 2,4- and 2,6-hexahydro-toluylene diisocyanate, as well as any mixtures of these isomers, hexahydro-1,3- and -1,4-phenylene diisocyanate, perhydro-2-4′- and -4,4′-diphenyl-methane-diisocyanate, 1,3- and 1,4-phenylene diisiocyanate, 1,4-durol diisocyanate (DDI), 4,4′-stilbene diisocyanate, 3,3′-dimethyl-4,4′-biphenlyene diisocyanate (TODI), 2,4- and 2.6-toluylene diisocyanate (TDI), as well as any mixtures of these isomers, diphenylmethane-2,4′- and/or -4,4′-diisocyanate (MDI), or naphthylene-1,5-diisocyanate (NDI).

Also suitable to be used as an organic isocyanate in the present invention are, for example, triphenyl methane-4,4′,4″-triisocyanate, polyphenyl-polymethylene-polyisocyanates, such as are obtained by aniline-formaldehyde condensation and subsequent phosgenation and as described in, for example, e.g. in GB-PS 874 430 and GB-PS 848 671, m- and p-isocyanato-phenylsulfonyl isocyanates according to U.S. Pat. No. 3,454,606, the disclosure of which is herein incorporated by reference, perchlorinated aryl polyisocyanates such as are described in U.S. Pat. No. 3,277,138, the disclosure of which is herein incorporated by reference, polyisocyanates comprising carbodiimide groups, such as are described in U.S. Pat. No. 3,152,162, the disclosure of which is herein incorporated by reference, and in U.S. Pat. No. 4,294,719 (believed to correspond to DE-OS 25 04 400), the disclosure of which is herein incorporated by reference, U.S. Pat. No. 4,088,665 (believed to correspond to DE-OS 25 37 685), the disclosure of which is herein Incorporated by reference), and U.S. Pat. No. 4,344,855 (believed to correspond to DE-OS 25 52 350), the disclosure of which is herein incorporated by reference, norbornanc-diisocyanates according to U.S. Pat. No. 3,492,301, the disclosure of which is herein incorporated by reference, polyisocyanates comprising allophonate groups, such as are described in GB-PS 994 890, BE-PS 761 626 and. U.S. Pat. No. 3,769,318 (believed to correspond to NL-A 7 102 524), the disclosure of which is herein incorporated by reference, polyisocyanates comprising isocyanurate groups, such as are described in U.S. Pat. No. 3,001,9731, the disclosure of which is herein incorporated by reference, in DE-PS 10 22 789, 12 22 067 and 1 027 394, as well as in DE-OS 1 929 034 and U.S. Pat. Nos. 3,738,947 and 3,879,316 (which are believed to correspond to DE-OS 2 004 048), the disclosures of which are herein incorporated by reference, polyisocyanates comprising urethane groups, such as are described e.g. in BE-PS 752 261 or in U.S. Pat. Nos. 3,394,164 and 3,644,457, the disclosures of which are herein incorporated by reference, polyisocyanates comprising acylated urea groups according to DE-PS 1 230 778, polyisocyanates comprising biuret groups, such as are described in U.S. Pat. Nos. 3,124,605, 3,201,372 and 3,124,605, the disclosures of which are herein incorporated by reference, as well as in GB-PS 889 050, polyisocyanates produced by telomerisation reactions, such as are described in U.S. Pat. No. 3,654,106, the disclosure of which is herein incorporated by reference, polyisocyanates comprising ester groups, such as are described in GB-PS 965 474 and 1 072 956, in U.S. Pat. No. 3,567,763, the disclosure of which is herein incorporated by reference, and in DE-PS 12 31 688, conversion products of the above-mentioned isocyanates with acetals according to DE-PS 1 072 385 and polyisocyanates containing polymeric fatty acid esters according to U.S. Pat. No. 3,455,883, the disclosure of which is herein incorporated by reference.

It is also possible to use the distillation residues comprising isocyanate groups that are obtained during commercial isocyanate production, and which are optionally dissolved in one or more of the aforementioned polyisocyanates. It is in addition possible to use any mixtures of the aforementioned isocyanates.

Preferably, the polyisocyanates used are those polyisocyanates which are easily available commercially, e.g. the 2,4- and 2,6-toluylene diisocyanate and any mixtures of said isomers (“TDI”), 4,4′-diphenylmethane diisocyanate, 2,4′-diphenylmethane diisocyanate, 2,2′-diphenylmethane diisocyanate and polyphenyl-polymethylene-polyisocyanates, such as are produced by aniline-formaldehyde condensation and subsequent phosgenation (“crude MDI”) and polyisocyanates comprising carbodiimide groups, uretonimine groups, urethane groups, allophonate groups, isocyanurate groups, urea groups or biuret groups (“modified polyisocyanates”), in particular the modified polyisocyanates which are derived from 2,4- and/or 2,6-toluylene diisocyanate or from 4,4′- and/or 2,4′-diphenylmethane diisocyanate. Naphthylene-1,5-diisocyanate and mixtures of the polyisocyanates mentioned are also highly suitable.

It is particularly preferable, in the process according to the invention, to use prepolymers comprising isocyanate groups. Suitable prepolymers are produced by the reacting of at least one partial amount of polyol component b1), b2.1), b2.2) or b2.3), or a mixture thereof, and/or chain extender/crosslinking agent c) with at least one aromatic diisocyanate from the group TDI, MDI, TODI, DIBDI, NDI, DDI, preferably with 4,4′-MDI and/or 2,4-TDI and/or 1,5-NDI., to yield a polyaddition product comprising urethane groups and isocyanate groups and having an NCO content of 6 to 35 wt. %, preferably of 10 to 25 wt. %. The prepolymers comprising isocyanate groups can be produced in the presence of catalysts. It is also possible, however, to produce the prepolymers comprising isocyanate groups in the absence of catalysts, and to incorporate the latter in the reaction mixture only for the production of PU elastomers. There can also be added to the prepolymer; in order to change the viscosity and increase the gas uptake, non-reactive additives, low-molecular weight esters such as phthalates, adipates, and also ring esters, cyclic carbonates and terminally blocked polyethers. The term “polyetherester polyol” as used herein is understood to mean a compound that comprises ether groups, ester groups and OH groups.

The polyetherester polyols suitable for component b1) in accordance with the present invention have a number-average molecular weight of 800 g/mol to 6,000 g/mol, preferably of 1,200 g/mol to 4,000 g/mol, and have a number-average hydroxyl functionality of 1.7 to 4, preferably of 1.8 to 2.7, and a ratio by weight of ether groups to ester groups of 0.05:0.95 to 0.48:0.52, particularly preferably of 0.08:0.92 to 0.3:0.7.

Organic dicarboxylic acids b1.1) include those acids having up to 12 carbon atoms which are suitable for producing polyetherester polyols including, preferably aliphatic dicarboxylic acids having 4 to 6 carbon atoms, which are used individually or in a mixture. Suberic acid, azelaic acid, decanedicarboxylic acid, maleic acid, malonic acid, phthalic acid, pimelic acid and sebacic acid may be mentioned as examples. Fumaric acid and succinic acid are particularly suitable and glutaric acid and adipic acid are most particularly suitable. There can be used as b1.1) derivatives of these acids such as, for example, the corresponding anhydrides and also the corresponding esters and half-esters with low molecular-weight, monofunctional alcohols having 1 to 4 carbon atoms.

Suitable compounds to be used as component b1.2), which are used in producing the polyetherester polyols b1), include, for example, as component (a) those polyether polyols that are obtained by the alkoxylation of starter molecules, preferably polyvalent alcohols. The starter molecules are at least difunctional, but can also optionally contain portions of higher functional, in particular trifunctional, starter molecules. The alkoxylation takes place conventionally in two steps. First of all, alkoxylation is carried out in the presence of basic catalysts or double-metal cyanide catalysts with preferably propylene oxide, or less preferably 1,2-butylene oxide, or less preferably 2,3-butylene oxide, and then ethoxylation with ethylene oxide is carried out. The portion of ethylene oxide in the polyether polyol is 10 wt. % to 40 wt. %, preferably 15 wt. % to 35 wt. %, most preferably 18 wt. % to 32 wt. %.

Also suitable to be used in component (b) as component b1.2) are (b) the ether-based polymer polyols having OH numbers of 10 to 149 and average functionalities of 1.7 to 4, that contain 1 to 50 wt. % of solids, based on the total weight of the ether-based polymer polyol. These ether-based polymer polyols are preferably polymer-modified polyols, and more preferably graft polymer polyols based on polyethers. Suitable graft components include, preferably, those based on styrene and/or acrylonitrile which are produced by the in situ polymerization of acrylonitrile, styrene, or more preferably mixtures thereof, in weight ratios of, for example, 90:10 to 10:90, preferably 70:30 to 30:70. The polymer polyols can be present as polyol dispersions that contains a disperse phase, conventionally in amounts of 1 to 50 wt. % and preferably 1 to 45 wt. % solids, based on the weight of the total amount of the Component b1.2) (b). Examples of such polymer polyols include polyurethanes containing ureas (i.e. PHD polyols), polyhydrazides and tertiary amino groups in bonded form.

Suitable compounds to be used as component b1.3) include, for example, mainly diols having primary OH groups and number-average molecular weights of 62 g/mol to 750 g/mol, preferably of 62 g/mol to 400 g/mol, most preferably of 62 g/mol to 200 g/mol. Other suitable compounds which may be mentioned as examples include compounds such as 1,3-propanediol, 1,5-pentenediol, 1,5-pentanediol, neopentylglycol, 1,6-hexanediol, 1,7-heptanediol, octanediol-1,8, 1,10-decanediol, 2-methyl-1,3-propanediol, 2,2-dimethyl-1,3-propanediol, 3-methyl-1,5-pentanediol; 2-butyl-2-ethyl-1,3-propanediol, 2-butene-1,4-diol and but-2-yne-1,4-diol, triethylene glycol, tetraethylene glycol, dibutylene glycol, tributylene glycol, tetrabutylene glycol, dihexylene glycol, trihexylene glycol, tetrahexylene glycol, oligomeric mixtures of alkylene glycols and in particular 1,2-ethanediol, 1,4-butanediol and diethylene glycol.

In addition, other compounds may also be used, in combination with the diols, of polyols with number-average functionalities of more than 2 to 8, preferably of 2.1 to 5, particularly preferably of 3 to 4, such as, for example, 1,1,1-trimethylolpropane, triethanolamine, glycerol, sorbitan and pentaerythritol, as well as polyethylene oxide polyols started on triols or tetraols with average molecular weights of 62 g/mol to 750 g/mol, preferably of 62 g/mol to 400 g/mol, and most preferably of 62 g/mol to 200 g/mol.

Of the group of the diols, each one can be used individually on its own or in combination with other diols and polyols. The diols and polyols can also be added subsequently to a polyester polyol, even if they are not thereby converted in the esterification reaction, or not until the attainment of polycondensation equilibrium. The relative quantitative use of the various polyols is limited by the predetermined number-average hydroxyl functionality of the polyetherester polyol b1).

Suitable compounds to be used as ester-based polymer polyols for both components b1.4) and b2.1) in accordance with the present invention include compounds such as, for example, the polymer-modified polyols, and in particular graft polymer polyols based on polyesters or polyetheresters. As graft component of a graft polymer polyol, suitable compounds for this component include, in particular, ones based on styrene and/or acrylonitrile that are produced by the in situ polymerisation of acrylonitrile, styrene, or preferably mixtures of styrene and acrylonitrile in, e.g. a ratio by weight 90:10 to 10:90, and preferably 70:30 to 30:70. The polymer polyols can be present as polyol dispersions that contain as disperse phase, conventionally in amounts of 1 to 50 wt. %, preferably 1 to 45 wt. % of solids, based on the total weight of the polymer polyol component, e.g. polyurethanes containing polyureas (PE)), polyhydrazides and tertiary amino groups in bonded form.

The mixture b2) consists of components b2.1) and b2.2).

Suitable polyester polyols to be used as component (a) of component b2.1), the polyester polyol component, can be produced, for example, from organic dicarboxylic acids having 2 to 12 carbon atoms, preferably aliphatic dicarboxylic acids having 4 to 6 carbon atoms, with polyvalent alcohols, preferably diols, having 2 to 12 carbon atoms, preferably 2 to 6 carbon atoms. Suitable compounds to be used as dicarboxylic acids include compounds such as, for example, succinic acid, malonic acid, glutaric acid, adipic acid, suberic acid, azelaic acid, sebacic acid, decanecarboxylic acid, maleic acid, fumaric acid, phthalic acid, isophthalic acid and terephthalic acid. The dicarboxylic acids can moreover be used both individually and as mixtures with one another. Instead of the free dicarboxylic acids, the corresponding dicarboxylic acid derivatives can also be used. These derivatives include, for example, dicarboxylic acid-mono- and/or -diesters of alcohols having 1 to 4 carbon atoms, or dicarboxylic acid anhydrides. It is preferred to use dicarboxylic acid mixtures of succinic, glutaric and adipic acid in quantitative proportions of, for example, 20 to 35/35 to 50/20 to 32 parts by weight, respectively, and, it is particularly preferred to use adipic acid. Examples of suitable divalent alcohols and polyvalent alcohols include compounds such as ethanediol, diethylene glycol, 1,2- and 1,3-propanediol, dipropylene glycol, methylpropane diol-1,3, 1,4-butanediol, 1,5-pentanediol, 1,6-hexanediol, neopentylglycol, 1,10-decanediol, glycerol, trimethylolpropane and pentaerythritol. Preferably, the divalent alcohols and polyvalent alcohols used are 1,2-ethanediol, diethylene glycol, 1,4-butanediol, 1,6-hexanediol, glycerol, trimethylolpropane, or mixtures of at least two of the above-mentioned diols, with mixtures of ethanediol, diethylene glycol, 1,4-butanediol and 1,6-hexanediol, glycerol and/or trimethylolpropane being particularly preferred. It is also possible to use polyester polyols produced from lactones such as, e.g. ε-caprolactone, or from hydroxycarboxylic acids, e.g. o-hydroxycapronic acid and hydroxyacetic acid. Polycarbonates comprising hydroxyl groups are also suitable as polyester polyols for component b2.1) of the invention.

Preferred are polyester polyols which have a number-average molecular weight of 1,000 to 4,000, and a functionality of 1.7 to 4, more preferably 1.8 to 3.5.

Compound (b) the ester-based polymer polyols suitable for use as component b2.1) of the present invention, include the ester-based polymer-modified polyols which have been described above under component b1.4).

Suitable polyether polyols to be used as component b2.2) include (a) those polyether polyols that are obtained by the alkoxylation of starter molecules, preferably polyvalent alcohols. The starter molecules are at least difunctional, but may also optionally contain portions of higher functional, and in particular trifunctional, starter molecules. The alkoxylation takes place conventionally in two steps. First of all, alkoxylation is carried out in the presence of, for example, basic catalysts or double-metal cyanide catalysts, with preferably propylene oxide or less preferably 1,2-butylene oxide and/or 2,3-butylene oxide, and then ethoxylation with ethylene oxide is carried out. The portion of ethylene oxide in the resultant polyether polyol (a) is 10 wt. % to 40 wt. %, preferably 15 wt. % to 35 wt. %, particularly preferably 18 wt. % to 32 wt. %.

In addition, suitable polyether polyols to be used as component b2.2) include (b) the ether-based polymer polyols. Such ether-based polymer polyols are preferably polymer-modified polyols, and in particular graft polymer polyols based on polyethers. Suitable graft components include, preferably, those based on styrene and/or acrylonitrile that are produced by the in situ polymerization of acrylonitrile, styrene, or more preferably mixtures of styrene and acrylonitrile, in weight ratios of, for example, 90:10 to 10:90, preferably 70:30 to 30:70. The polymer polyols can be present as polyol dispersions that contain a disperse phase, conventionally in amounts of 1 to 50 wt. %, preferably 1 to 45 wt. % solids, based on the total amount of the component. Examples of such polymer polyols include polyurethanes containing polyureas (PHD polyols), polyhydrazides and tertiary amino groups in bonded form.

Chain extension agents and/or crosslinking agents are used as component c). Such chain extension/crosslinking agents are used for modifying the mechanical properties, and in particular, the hardness of the molding. Suitable chain extenders and/or crosslinkers include, for example, mainly those diols having primary OH groups and number-average molecular weights of less than 750 g/mol, preferably of 62 g/mol to 400 g/mol, and most preferably of 62 g/mol to 200 g/mol. Suitable compounds which may be mentioned as examples include compounds such as 1,3-propanediol, 1,5-pentenediol, 1,5-pentanediol, neopentylglycol, 1,6-hexanediol, 1,7-heptanediol, octanediol-1,8, 1,10-decanediol, 2-methyl-1,3-propanediol, 2,2-dimethyl-1,3-propanediol, 3-methyl-1,5-pentanediol; 2-butyl-2-ethyl-1,3-propanediol, 2-butene-1,4-diol and but-2-yne-1,4-diol, triethylene glycol, tetraethylene glycol, dibutylene glycol, tributylene glycol, tetrabutylene glycol, dihexylene glycol, trihexylene glycol, tetrahexylene glycol, oligomeric mixtures of alkylene glycols, and most preferably 1,2-ethanediol, 1,4-butanediol and diethylene glycol.

It is also possible to use, in addition to the diols as described above, polyols having number-average functionalities of more than 2 to about 8, preferably of 2.1 to 5, and most preferably of 3 to 4. Examples of such polyols include compounds such as, e.g. 1,1,1-trim-ethylolpropane, triethanolamine, glycerol, sorbitan and pentaerythritol, as well as polyethylene oxide polyols started on triols or tetraols which have average molecular weights of less than 750 g/mol, preferably of 62 g/mol to 400 g/mol, and most preferably of 62 g/mol to 200 g/mol.

Of the suitable diols, each one can be used individually by itself, or in combination with other diols and/or with the above described low molecular weight polyols.

Crosslinking agents include, in additional to the aforementioned polyols, e.g. triols, tetraols, oligomeric polyalkylene polyols, aromatic and/or aliphatic amines and/or diamines with a functionality of 2 to 8, preferably of 2 to 4, which conventionally possess molecular weights of less than 750 g/mol, preferably of 62 to 400 g/mol, and most preferably of 62 to 200 g/mol.

Component c) is present preferably in an amount of 5 to 25 wt. %, based on 100% by weight of components b) and c).

Suitable blowing agents to be used as component d) in accordance with the present invention, include those blowing agents selected from the group consisting of d1), d2) and mixtures thereof. Suitable blowing agents to be used as component d1) include those compounds selected from the group consisting of nitrogen, air, carbon dioxide and mixtures thereof. It is advantageous in the present invention to add the gases from d1) to components a) and/or b) at pressures above atmospheric pressure, and preferably between 1 and 11 bar absolute.

Suitable compounds to be used as component d2) of the blowing agents d) include, for example, those physical blowing agents that vaporise under the influence of the exothermic polyaddition reaction and which preferably have a boiling point, under standard pressure, in the range of −30 to 75° C. Chemical blowing agents such as water and carbamates can also suitable. By way of example, there may be mentioned compounds such as, e.g. acetone, ethyl acetate, halogen-substituted alkanes, perhalogenated alkanes, such as R134a, R141b, R365mfc, R245fa, butane, pentane, cyclopentane, hexane, cyclohexane, heptane or diethyl ether, as well as mixtures thereof. A blowing effect can also be achieved by the addition of compounds that decompose at temperatures above room temperature with the release of gases such as, for example, of nitrogen and/or carbon dioxide. Some examples of these compounds include azo compounds, e.g. azodicarbon-amide or azoisobutyronitrile, or salts such as ammonium bicarbonate, ammonium carbamate or ammonium salts of organic carboxylic acids, e.g. monoammonium salts of malonic acid, boric acid, formic acid or acetic acid. Further examples of suitable blowing agents for component d2) of the present invention, and details on the use of such blowing agents are described in, for example, R. Vieweg, A. Höchtlen (Ed.): “Kunststoff-Handbuch”, Vol. VII, Carl-Hanser-Verlag, Munich, 3rd edition, 1993, pp. 115 to 118, 710 to 715.

One or more emulsifiers, i.e. component e), can also be added if necessary. Emulsifies are preferred, particularly if water is used as blowing agent d2). Anionic, cationic, amphoteric or nonionic (neutral) emulsifiers can also be used as component e).

Optionally, further additives and/or auxiliary agents f) can be used to produce the moldings. By way of example, there may be mentioned additives such as surface-active additives such as foam stabilizers, cell regulators, flame retardants, nucleating agents, oxidation retardants, stabilizers, lubricants and mold release agents, fillers, dyestuffs, dispersion aids and pigments. Reaction delaying agents, flame retardants, antistatic agents, stabilizers against ageing and weathering effects, plasticizers, viscosity regulators and substances with a fungiostatic and bacteriostatic effect can also be used.

Suitable catalysts to be as component g) of the present invention include, for example, the known amine catalysts, e.g. tertiary amines such as triethylamine, tributylamine, N-methyl-morpholine, N-ethyl-morpholine, N,N,N′,N′-tetramethyl-ethylenediamine, pentamethyl-diethylene-triamine and higher homologues, 1,4-diaza-bicyclo-[2,2,2]-octane, N-methyl-N′-dimethylaminoethyl-piperazine, bis-(dimethylaminoalkyl)-piperazine, N,N-dimethylbenzylamine, N,N-dimethyl-cyclohexylamine, N,N-diethylbenzylamine, bis-(N,N-diethylaminoethyl)adipate, N,N,N′,N′-tetramethyl-1,3-butanediamine, N,N-dimethyl-β-phenyl-ethyl-amine, bis-(dimethyl-aminopropyl)-urea, bis-(dimethylaminopropyl)-amine, 1,2-dimethylimidazole, 2-methylimidazole, diazabicycloundecene, monocyclic and bicyclic amidines, bis-(dialkylamino)-alkyl ethers, such as bis(dimethylaminoethyl)ether, as well as tertiary amines comprising amide groups (preferably formamide groups). Also suitable to be used as catalysts herein are Mannich bases from secondary amines, such as, e.g. dimethylamine, and aldehydes, preferably formaldehyde, or ketones such as, e.g. acetone, methyl ethyl ketone or cyclohexanone, and phenols such as, e.g. phenol, N-nonylphenol or bisphenol A. Suitable tertiary amines containing Zerewittinoff-active hydrogen atoms with respect to isocyanate groups that can also be considered as catalysts in accordance with the present invention include, e.g. triethanolamine, triisopropanolamine, N-methyl-diethanolamine, N-ethyl-diethanolamine, N,N-dimethyl-ethanolamine, their conversion products with alkylene oxides such as propylene oxide and/or ethylene oxide as well as secondary-tertiary amines. Sila-amines with carbon-silicon bonds can also be used as catalysts. Examples of such sila-amines include 2,2,4-trimethyl-2-silamorpholine and 1,3-diethyl-aminomethyl-tetramethyl-disiloxane. In addition, nitrogenous bases such as tetraalkylammonium hydroxides, and also hexahydrotriazines, can also be considered as suitable catalysts. The reaction between NCO groups and Zerowitinoff-active hydrogen atoms is also strongly accelerated by lactams and azalactams. In accordance with the present invention, other suitable additional catalysts include, for example, organic metal compounds of tin, titanium and bismuth, and preferably organic tin compounds. Suitable compounds to be used as organic tin compounds, in addition to sulfur-containing compounds such as di-n-octyl-tin-mercaptide, include preferably tin(II)-salts of carboxylic acids, such as tin(II)-acetate, tin(II)-octoate, tin(II)-ethylhexoate, tin(II)-laurate, and tin(IV) compounds such as, e.g. dibutyltin oxide, dibutyltin dichloride, dibutyltin diacetate, dibutyltin dilaurate, dibutyltin maleate or dioctyltin diacetate.

The moldings according to the invention can be produced from components a) to f). These moldings are dimensionally accurate and are produced without so-called nuclear burn.

The moldings of the present invention are used preferably as shoe soles, and are particularly suitable to be used as shoe in-soles. These moldings can also be used as plates and shoe components.

The invention will be explained in detail by means of the following examples. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all percentages are percentages by weight.

### EXAMPLES

The production of the polyurethane specimens was carried out in such a way that the so-called “A” component (isocyanate group-containing component) was mixed at 45° C. in a low-pressure processing machine, i.e. an RGE 612 of the firm Klöckner DESMA Schuhmaschinen GmbH, with the so-called “B” component (i.e. a combination of components b) to f) as described below) at 45° C. The mixture was fed into an aluminium mold pre-heated to 60° C., the mold was closed and the components allowed to fully react. The molded elastomer was removed from the mould after 4 minutes. The metering of the gaseous blowing agents into the component “A” and “B” was carried out via a pressure-reducing valve (pressure <6 bar) into a blowing/mixing head and via a recirculation cycle up to pressure compensation between machine container and blowing/mixing head. The compositions are set forth in Table 1.

Starting Components:

Isocyanates:

Prepolymer 1 (P1):

60.0 parts by wt. of 4,4′-diisocyanatodiphenylmethane (4,4′-MDI, having a NCO content 33.6 wt. %) and 6.5 parts by wt. of carbodiimide-modified 4,4′-MDI were mixed at 50° C. with 33.5 parts by wt. of polyethylenebutylene adipate (having an OH number of 56) and heated to 80° C. for two hours under nitrogen. The resultant product was a clear liquid characterized by the following indicators:

NCO content=20.7 wt. %

Viscosity at 25° C. approx. 1100 mPa·s

Prepolymer 2 (P2):

46.0 parts by wt. of 4,4′-diisocyanatodiphenylmethane (having a NCO content 33.6 wt. %) and 5 parts by wt. of carbodiimide-modified 4,4′-MDI were mixed at 50° C. with 49 parts by wt. of polyethylenebutylene adipate (having an OH number=29) and heated to 80° C. for two hours under nitrogen. The resulting product was a clear liquid, characterized by the following indicators:

NCO content=16 wt. %

Viscosity at 25° C. approx. 5500 mPa·s

Polyols:

The following materials are used as polyol components:

1. Polyester polyol (X1): linear polyethylenebutylene adipate, OH number=55

2. Polyester polyol (X2): linear polyethylenebutylenecarboxylic acid ester based on commercial glutaric acid, OH number=55

3. Polyether polyol (X3): linear polyoxypropyleneoxyethylene block-copolyether diol, OH number=28

4. Polymer polyol (X4): polyoxypropyleneoxyethylene block-copolyether triol (OH number=35), which contains 40 wt. % of styrene-acrylonitrile (SAN).

Dabco krist: Dabco Crystal, an amine catalyst commercially available from Air Products

DC 193: Dabco DC 193 surfactant, a commercially available foam stabilizer from Air Products

LK 443: Dabco LK 443 surfactant, a commercially available foam stabilizer from Air Products

365 mfc: Solkane 365 mfc, a commercially available blowing agent from Solvay

TABLE 1
Compositions in parts by wt.

| Example | 1* | 2 | 3 | 4 | 5 |
|---|---|---|---|---|---|
| Polyester Polyol X1 | 100 | 90 | | 85 | 90 |
| Polyester Polyol X2 | | | 85 | | |
| Polyether Polyol X3 | | 10 | 5 | | 10 |
| Polymer Polyol X4 | | | 10 | 15 | |
| Ethylene glycol | 15 | 15 | 12 | 15 | 15 |
| Dabco krist. | 0.4 | 0.4 | 0.4 | 0.4 | 0.4 |
| Water | 0.6 | 0.58 | 0.59 | 0.61 | 0.1 |
| 365 mfc | | | | | 2 |
| DC193 | 0.2 | 0.2 | 0.2 | 0.2 | 0.2 |
| LK443 | 0.95 | 0.95 | 0.95 | 0.95 | 0.95 |
| CO₂ [bar] | 4.9 | 5.0 | 4.9 | 4.8 | 5.1 |
| P1 | | | 108.41 | 32.4 | 116.3 |
| P2 | 161.7 | 164 | | | |

*Comparison example

TABLE 2
Properties

| Example | 1* | 2 | 3 | 4 | 5 |
|---|---|---|---|---|---|
| Free-rise foam density [kg/m³] | 145 | 115 | 129 | 119 | 116 |
| Shrinkage of the free-rise foam | −− | + | + | + | + |
| after 20 min. | | | | | |
| Pore structure | Coarse | Fine | Medium | Fine | Fine |
| Molding density [kg/m³] | 276 | 232 | 243 | 238 | 229 |
| Shrinkage of the molding in | >5* | 0.9 | 1.3 | 1.1 | 1.5 |
| [%] after 48 h | | | | | |
| Mold embossing | − | + | + | + | ++ |
| Skin condition | −− | ++ | + | + | ++ |
| Hardness [Shore A] | ** | 32 | 29 | 37 | 35 |

*molding deformed
** not measurable
−− very poor
− poor
o satisfactory
+ good
++ very good

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A flexible moldings of foamed polyurethane having a molded density of less than 500 kg/m³ and a maximum molding shrinkage of 1.5% (as measured by DIN ISO 02769), comprising the reaction product of:
a) one or more organic isocyanates having 2 to 4 NCO groups per molecule and an NCO content of 6 to 49 wt. %;
b) at least one polyol component selected from the group consisting of:
b1) one or more polyetherester polyols with a number-average molecular weight of 800 g/mol to 6,000 g/mol, a number-average functionality of 1.7 to 4 and a ratio by weight of ether groups to ester groups of the polyetherester polyol of 0.05:0.95 to 0.48:0.52, wherein the polyetherester polyols comprise the polycondensation product of:
b1.1) one or more dicarboxylic acids having up to 12 carbon atoms and/or their derivatives,
b1.2) one or more polyether polyol components selected from the group consisting of:
(a) one or more polyether polyols having a number-average molecular weight of 1,000 g/mol to 8,000 g/mol, an average functionality of 1.7 to 4 and an ethylene oxide content of 10 to 40 wt. %, and
(b) one or more ether-based polymer polyols having OH numbers of 10 to 149 and average functionalities of 1.7 to 4, which contain 1 to 50 wt. % of solids, based on the weight of the total amount of (b),
b1.3) one or more polyols having a number-average molecular weight of 62 to 750 g/mol, a number-average functionality of 2 to 8 and having at least 2 terminal OH groups per molecule,
and, optionally,
b1.4) one or more ester-based polymer polyols having OH numbers of 10 to 149 and average functionalities of 1.7 to 4, and which contain from 1 to 50 wt. % of solids, based on the weight of the total amount of b1.4), and
b2) a mixture of
b2.1) from 52 to 95 wt. %, based on 00% of the combined weight component selected from the group consisting of:
(a) one or more polyester polyols having a number-average molecular weight of 1000 to 4000 g/mol and a functionality of 1.7 to 4, and
(b) one or more ester-based polymer polyols having OH numbers of 10 to 149 and average functionalities of 1.7 to 4, and which contain from 1 to 50 wt. % of solids, based on the weight of the total amount of (b),
b2.2) from 5 to 48 wt. %, based on 100% of the combined weight of b2.1) and b2.2), of at least one polyether polyols selected from the group consisting of:
(a) one or more ethylene oxide group-containing polyether polyols having a number-average molecular weight of 900 to 18,000 g/mol, a functionality of 1.7 to 4 and an ethylene oxide content of 10 to 40 wt. %, and
(b) one or more ether-based polymer polyols having OH numbers of 10 to 149 and average functionalities of 1.7 to 4, and which contain from 1 to 50 wt. % of solids, based on the weight of the total amount of (b),
c) 5 to 25 wt. %, based on 100% of the combined weight of components b) and c), of crosslinking agents/chain extenders,
d) one or more blowing agent components selected from the group consisting of:
d1) nitrogen, air and/or carbon dioxide, and
d2) at least one component selected from the group consisting of chemical blowing agents and physical blowing agents with boiling points in the range of-30° C. to 75° C.,
and, optionally,
e) one or more emulsifiers,
f) one or more additives and auxiliary substances,
g) one or more catalysts,
wherein the Isocyanate Index is from 95 to 115.

2. The flexible moldings of claim 1 having a molded density of less than 350 kg/m³.

3. The flexible moldings of claim 1, wherein a) said organic isocyanate comprises a prepolymer containing isocyanate groups and having an NCO group content of 6 to 35 wt. %.

4. The flexible moldings of claim 1, wherein b1) said polyetherester polyol component has a number-average molecular weight of. 1,200 to 3,000 g/mol, a number-average functionality of 1.8 to 2.7, and a ratio by weight of ether groups to ester groups of the polyetherester polyol of 0.08:0.92 to 0.3:0.7.

5. The flexible moldings of claim 1, wherein b1.2) is selected from the group consisting of (a) one or more polyether polyols having a number average molecular weight of 1,500 g/mol to 6,000 g/mol, an average functionality of 1.8 to 2.7 and an ethylene oxide content of 15 to 35 wt. %, and (b) one or more ether-based polymer polyols having average functionalities of 1.8 to 3.5 and containing from 1 to 45 wt. % of solids.

6. The flexible moldings of claim 1, wherein b1.3) polyols have number average molecular weights of 62 g/mol to 400 g/mol.

7. The flexible moldings of claim 1, wherein b2) comprises a mixture of
b2.1) at least one polyester polyol component selected from the group consisting of:
(a) one or more polyester polyols having a number average molecular weight of 1,000 to 4,000 and a functionality of 1.8 to 3.5, and
(b) one or more ester-based polymer polyols having an OH number of 10 to 149, average functionalities of 1.8 to 3.5 and which contain 1 to 45 wt. % solids, and
b2.2) one or more polyether polyols selected from the group consisting of
(a) one or more ethylene oxide group-containing polyether polyols having a number-average molecular weight of 2,000 to 8,000 g/mol, a functionality of 1.8 to 2.7 and an ethylene oxide content of 15 to 35 wt. %, and
(b) one or more ether-based polymer polyols having an OH number of 10 to 149, an average functionality of 1.8 to 3.5 and which contain 1 to 45 wt. % solids.

8. A process for the production of the flexible moldings of foamed polyurethane according to claim 1, comprising
A) reacting in a mold:
a) one or more organic isocyanates having 2 to 4 NCO groups per molecule and an NCO content of 6-49 wt. %; with
b) at least one polyol component selected from the group consisting of:
b1) one or more polyetherester polyols with a number-average molecular weight of 800 g/mol to 6000 g/mol, a number-average functionality of 1.7 to 4 and a ratio by weight of ether groups to ester groups of the polyetherester polyol of 0.05:0.95 to 0.48:0.52, wherein the polyetherester polyols comprise the polycondensation product of
b1.1) one or more dicarboxylic acids having up to 12 carbon atoms and/or their derivatives,
b1.2) one or more polyether polyol components selected from the group consisting of:
(a) one or more polyether polyols having a number-average molecular weight of 1000 g/mol to 8000 g/mol, an average functionality of 1.7 to 4 and an ethylene oxide content of 10 to 40 wt. %, and
(b) one or more ether-based polymer polyols having OH numbers of 10 to 149 and average functionalities of 1.7 to 4, which contain 1 to 50 wt. % of solids, based on the weight of the total amount of (b),
b1.3) one or more polyols having a number-average molecular weight of 62 to 750 g/mol, a number-average functionality of 2 to 8 and having at least 2 terminal OH groups per molecule, and, optionally,
b1.4) one or more ester-based polymer polyols having OH numbers of 10 to 149 and average functionalities of 1.7 to 4, and which contain from 1 to 50 wt. % of solids, based on the weight of the total amount of b1.4), and
b2) a mixture of
b2.1) from 52 to 95 wt. %, based on 100% by weight of b2.1) and b2.2), of at least one polyester polyol component selected from the group consisting of:
(a) one or more polyester polyols having a number-average molecular weight of 1000 to 4000 g/mol and a functionality of 1.7 to 4, and
(b) one or more ester-based polymer polyols having OH numbers of 10 to 149 and average functionalities of 1.7 to 4, and which contain from 1 to 50 wt. % of solids, based on the weight of the total amount of (b),
b2.2) from 5 to 48 wt. %, based on 100% by weight of b2.1) and b2.2), of at least one polyether polyols selected from the group consisting of:
(a) one or more ethylene oxide group-containing polyether polyols having a number-average molecular weight of 900 to 18,000 g/mol, a functionality of 1.7 to 4 and an ethylene oxide content of 10 to 40 wt. %, and
(b) one or more ether-based polymer polyols having OH numbers of 10 to 149 and average functionalities of 1.7 to 4, and which contain from 1 to 50 wt. % of solids, based on the weight of the total amount of (b),
c) 5 to 25 wt. %, based on 100% by weight of components b) and c), of crosslinking agents/chain extenders,
d) one or more blowing agent components selected from the group consisting of:
d1) nitrogen, air and/or carbon dioxide, and
d2) at least one component selected from the group consisting of chemical blowing agents and physical blowing agents with boiling points in the range of −30° C. to 75° C.,
and, optionally,
e) one or more emulsifiers,
f) one or more additives and auxiliary substances,
optionally, in the presence of:
g) one or more catalysts,
wherein the Isocyanate Index is from 95 to 115, and
B) removing the resultant product from the mold.

9. The process of claim 8, wherein the resultant flexible moldings having a molded density of less than 350 kg/m³.

10. The process of claim 8, wherein a) said organic isocyanate comprises a prepolymer containing isocyanate groups and having an NCO group content of 6 to 35 wt. %.

11. The process of claim 8, wherein b1) said polyetherester polyol component has a number-average molecular weight of 1,200 to 3,000 g/mol, a number-average functionality of 1.8 to 2.7, and a ratio by weight of ether groups to ester groups of the polyetherester polyol of 0.08:0.92 to 0.3:0.7.

12. The process of claim 8, wherein b1.2) is selected from the group consisting of (a) one or more polyether polyols having a number average molecular weight of 1,500 g/mol to 6,000 g/mol, an average functionality of 1.8 to 2.7 and an ethylene oxide content of 15 to 35 wt. % and (b) one or more ether-based polymer polyols having average functionalities of 1.8 to 3.5 and containing from 1 to 45 wt. % of solids.

13. The process of claim 8, wherein b1.3) polyols have number average molecular weights of 62 g/mol to 400 g/mol.

14. The process of claim 8, wherein b2) comprises a mixture of
b2.1) at least one polyester polyol component selected from the group consisting of:
(a) one or more polyester polyols having a number average molecular weight of 1,000 to 4,000 and a functionality of 1.8 to 3.5, and
(b) one or more ester-based polymer polyols having an OH number of 10 to 149, average functionalities of 1.8 to 3.5 and which contain 1 to 45 wt. % solids, and
b2.2) one or more polyether polyols selected from the group consisting of
(a) one or more ethylene oxide group-containing polyether polyols having a number-average molecular weight of 2,000 to 8,000 g/mol, a functionality of 1.8 to 2.7 and an ethylene oxide content of 15 to 35 wt. %, and
(b) one or more ether-based polymer polyols having an OH number of 10 to 149, an average functionality of 1.8 to 3.5 and which contain 1 to 45 wt. % solids.
